(19) United States
(12) Patent Application Publication
(10) Pub. No.: US 2003/0094356 A1
(43) Pub. Date: May 22, 2003

(54) Switch mechanism for a power tool

(76) Inventor: Michael Waldron, Durham (GB)

Correspondence Address: Bruce S. Shapiro, The Black & Decker Corporation, 701 E. Joppa Road, Towson, MD, 21286, US

(21) Appl. No.: 10/289,878

(22) Filed: Nov. 7, 2002

(30) Foreign Application Priority Data
Nov. 20, 2001 (GB) 0127801.9

(51) Int. Cl. H01H 9/06

(52) U.S. Cl. 200/332.2

(57) ABSTRACT

A switch mechanism (40,48,64) for assisting accurate control of a power tool (2), which power tool (2) comprises a variable output (20) controlled by the switch mechanism (40,48,64) wherein the shape of at least one part (42,44) of the switch mechanism (40,48,64) which is activated by a user indicates the manner in which the switch mechanism (40,48,64) controls the output (20) when that part (42,44) of the switch mechanism (40,48,64) is activated.

The present invention relates to switch mechanisms for use on power tools and, in particular, to switch mechanisms for improving control of the output of power tools.

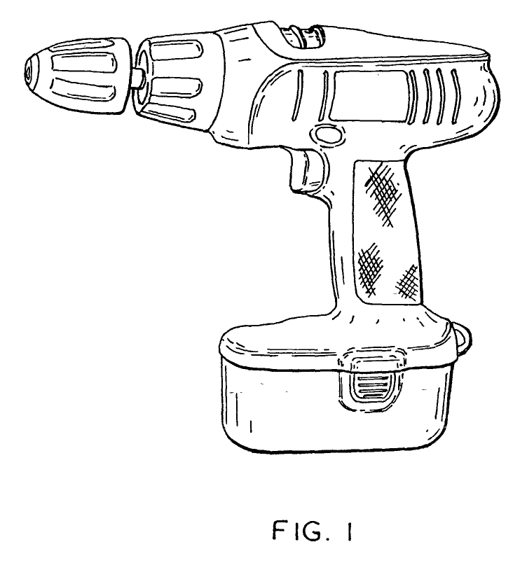

Electric drills and electric screwdrivers are well known in the art. It is also known to combine an electric drill with an electric screwdriver to produce a power tool resembling a conventional electric drill with added features to enable slow and controlled screw driving speeds in both rotational directions. One such power tool, referred to as a drill-driver, is shown in FIG. 1. This drill-driver comprises a body having a drill head portion and a handle portion fixed at approximately right angle to the drill head portion. The drill head portion encapsulates an electric motor and a gearbox and the handle portion defines a conventional pistol grip to be grasped by the user. The handle portion comprises a variable speed trigger switch for activating and controlling the rotational speed of the rotary output of the motor. For low-speed rotary output in screw driving mode the trigger switch is partially depressed and for high-speed rotary output in drilling mode the trigger switch is fully depressed. The rotary output of the motor is still when the trigger switch is released. The handle portion also comprises a direction selector switch for controlling the rotational direction of the rotary output when the output is activated by the trigger switch. The direction selector switch has a forward push button and a reverse push button located on opposite side of the handle to the forward push button. The push buttons are both round. The direction selector switch can slide between three in-line positions; forward rotation position, central zero rotation position and reverse rotation position. When the direction selector switch is in the forward rotation position depression of the trigger switch causes the rotary output to rotate clockwise to drive a screw or drill bit “forward” into a work piece. Conversely, when the direction selector switch is in the reverse rotation position depression of the trigger switch causes the rotary output to rotate anti-clockwise to “reverse” a screw or drill bit out of a work piece. Partial depression of the reverse push button moves the direction selector switch from the forward rotation position to the central zero rotation position and full depression of the reverse push button moves the direction selector switch from the central zero rotation position to the reverse rotation position. This sequence is reversed when the forward push button is depressed.

Whilst this direction selector switch is a reliable mechanism for controlling the rotational direction of the rotary output, a user cannot be relied upon to depress the correct push button of the direction selector switch. This is because the push buttons formed as a simple round shape which gives no indication of the intended purpose of either push button. As such, the user may easily mistake the forward push button for the reverse push button, or vise versa. Attempts have also been made to improve the utilage of the direction selector switch by adding a forward sign to the forward push button and a reverse sign to the reverse push button. However, such signs are necessarily small to fit on the head of the push button and the user must stop work and read the signs before operating the direction selector switch. Over time these markings may also be obscured, damaged or removed from the push buttons.

It is an object of the present invention to provide a switch mechanism of the type described at the outset, in which the disadvantages of conventional switch mechanisms is avoided, or at least reduced, by providing a simple and effective indication to the user of the intended result of operating the switch mechanism.

Accordingly there is provided a switch mechanism for assisting accurate control of a power tool, which power tool comprises a variable output controlled by the switch mechanism characterised in that the shape of at least one part of the switch mechanism which is activated by a user indicates the manner in which the switch mechanism controls the output when that part of the switch mechanism is activated. The switch mechanism may be an electrical switch, a mechanical switch or an electromechanical switch. The power tool may be a portable or stationary power tool with a rotating, reciprocating or vibrating output. The variation in the output value may be on/off, variable speed or variable frequency. The part of the switch mechanism activated by the user may be a button, lever or a wheel. The part of the switch mechanism activated by the user gives a tactile or clearly visible indication to a user of the manner in which the switch mechanism controls the output when that part of the switch mechanism is activated. This indication may be in the form of a raised and indelible marking moulded into the at least one part of the switch mechanism which is activated by a user. Alternatively, this indication may be given by the shape and/or orientation of the at least one part of the switch mechanism which is activated by a user.

Preferably, the switch mechanism controls the output by moving between a plurality of switch positions and the output is variable between a plurality of output values, each one of the plurality of switch positions corresponding to a respective output value. In this case one switch mechanism can perform several functions by controlling a plurality of different output values.

More preferably the at least one part of the switch mechanism comprises a plurality of buttons and the switch mechanism is moved to any one of the plurality of switch positions by activation of a respective button, each one of the plurality of buttons corresponding to a respective output value. A button can easily adopt an irregular shape without effecting the button's performance. For example, a button can be moulded into the shape of an arrow, to indicate direction, or a cross, to indicate stop. Buttons can be moulded into many other shapes. In any case, an irregularly shaped button can operated in the same manner as a regular shaped button.

Preferably each one of the plurality of buttons is shaped to indicate a respective corresponding output value. In this case the user is given a clear visual and tactile indication of the output value resulting from activation of a corresponding button.

Alternatively, the at least one part of the switch mechanism comprises two push buttons and the switch mechanism is moved to a corresponding switch position by depression of one of the two push buttons.

Preferably, the plurality of switch positions comprises a forward switch position corresponding to a forward output value, a central switch position corresponding to a zero output value, and a reverse switch position corresponding to a reverse output value. Also, the two push buttons comprise a forward button shaped as a forward orientated arrowhead and a reverse button shaped as a reverse orientated arrowhead. Depression of the forward button moves the switch mechanism to the forward switch position and depression of the reverse button moves the switch mechanism to the reverse switch position. Movement of the switch mechanism into the forward or reverse switch positions need not mean than the output is activated. However, if the output is activated and the switch mechanism is in the forward switch position then the output value will be the forward output value. The forward output value corresponds to a rotary output rotating in a clockwise direction to drive a screw or drill bit “forward” into a work piece. A forward button shaped as a forward-orientated arrowhead gives a user a clear visual and tactile indication of the effect on the output value of depressing the forward button. Conversely, if the output is activated and the switch mechanism is in the reverse switch position then the output value will be the reverse output value. The reverse output value corresponds to a rotary output rotating in an anti-clockwise direction to “reverse” a screw or drill bit out of a work piece. A reverse button shaped as a reverse orientated arrowhead gives a user a clear visual and tactile indication of the effect on the output value of depressing the reverse button.

Preferably, the central switch position is located between the forward switch position and the reverse switch position. The switch mechanism can be moved to the central switch position by depressing the forward button half way between the reverse switch position and the forward switch position, or vice versa. This has the advantage that the switch mechanism requires only two buttons for operation between three switch positions.

Preferably the power tool comprises a second switch for controlling the output. This has the advantage that the switch mechanism can control one aspect of the output value, like for example, the direction of the output, whilst the second switch controls another aspect of the output value like, for example, speed or frequency of the output. The second switch may be an electric switch, a mechanical switch or an electromechanical switch. More preferably control of the output value by the second switch is interdependent with the switch position of the switch mechanism. In this case, the switch mechanism and the second switch are coupled together so that the position of the switch mechanism can effect how the second switch controls the output value and vice versa. The switch mechanism and the second switch may be, for example, electrically coupled or mechanically coupled by a link mechanism or interlock.

Preferably the switch mechanism is direction selector switch and the second switch is an electrical power switch.

A preferred embodiment of the present invention will now be described by way of example only, with reference to the accompanying illustrative drawings in which:

FIG. 1 shows a conventional pistol grip drill-driver;

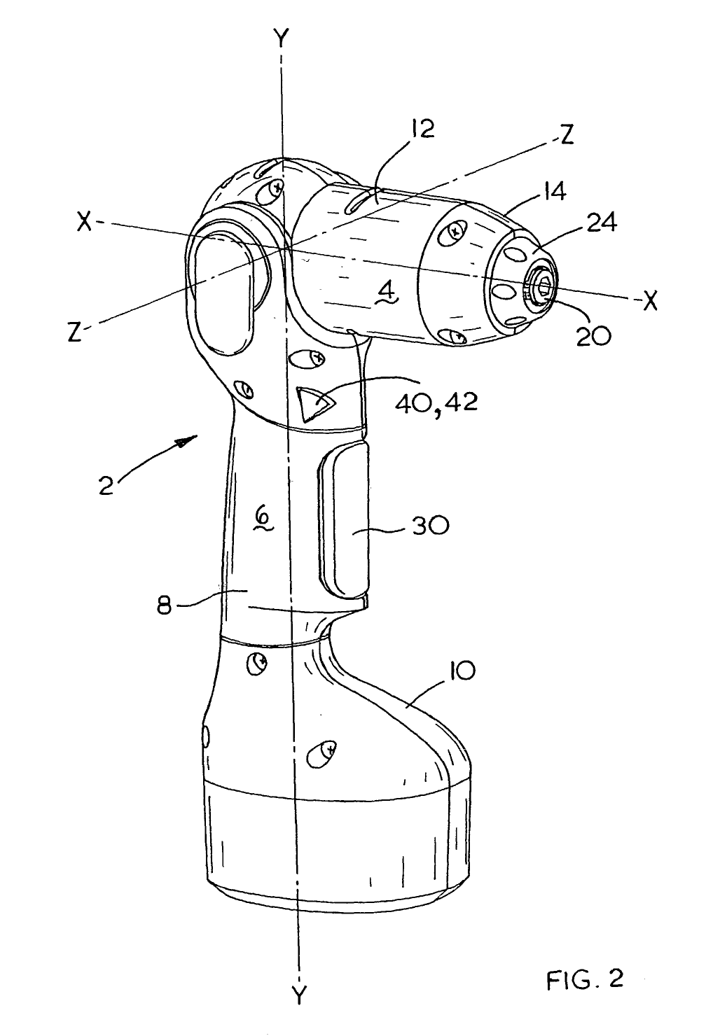

FIG. 2 shows a side perspective view of the power tool;

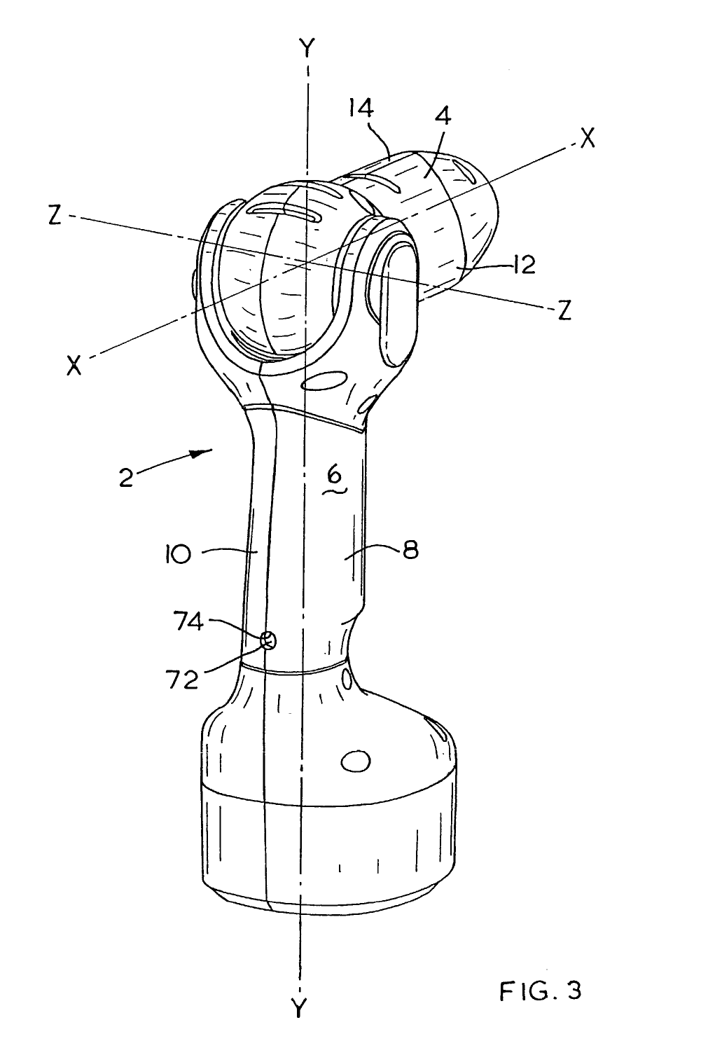

FIG. 3 shows a rear perspective view of the power tool;

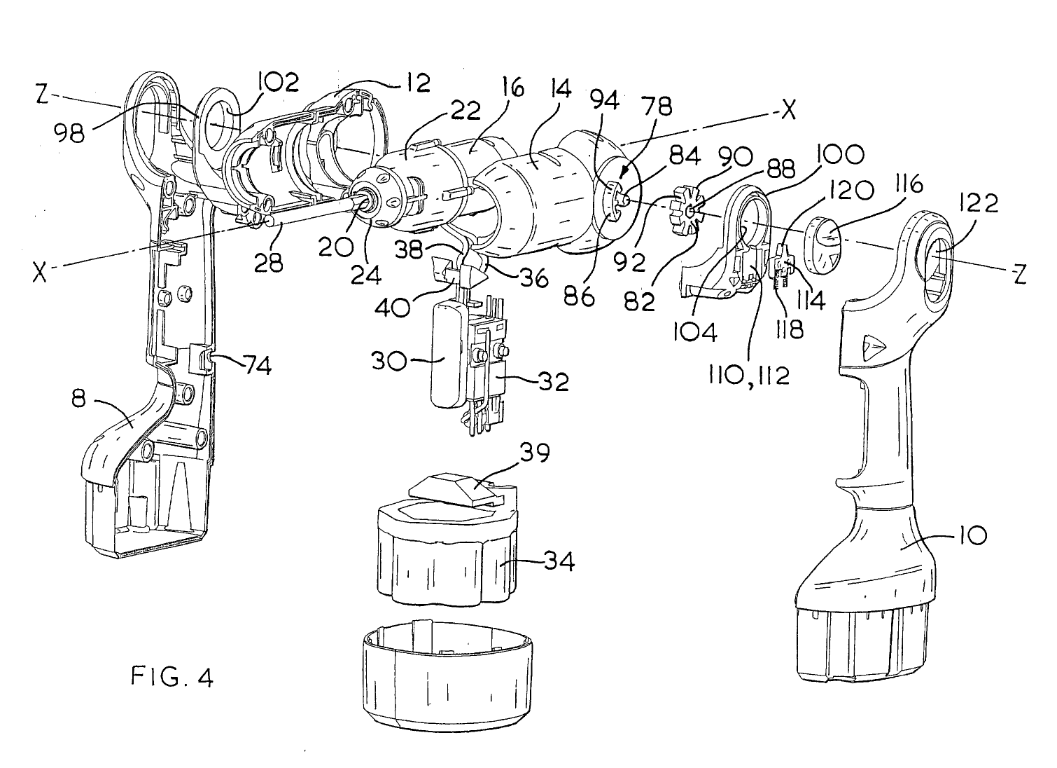

FIG. 4 shows an exploded perspective view of one side of the power tool;

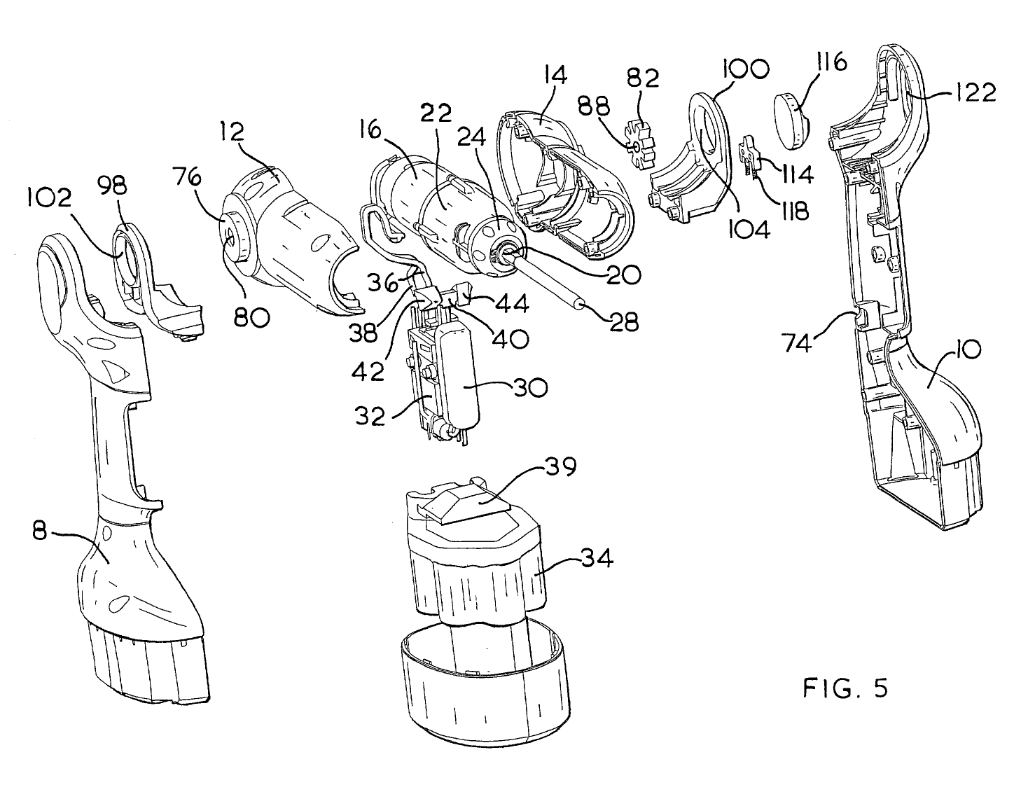

FIG. 5 shows an exploded perspective view of the other side of the power tool to that shown in FIG. 4;

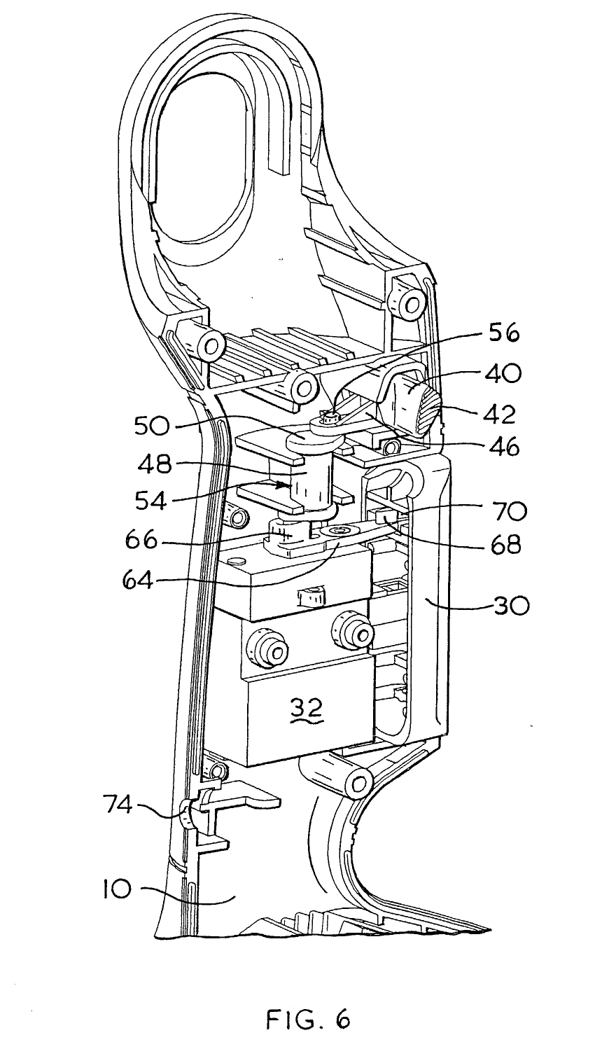

FIG. 6 shows a detailed view of the switch and the direction selector;

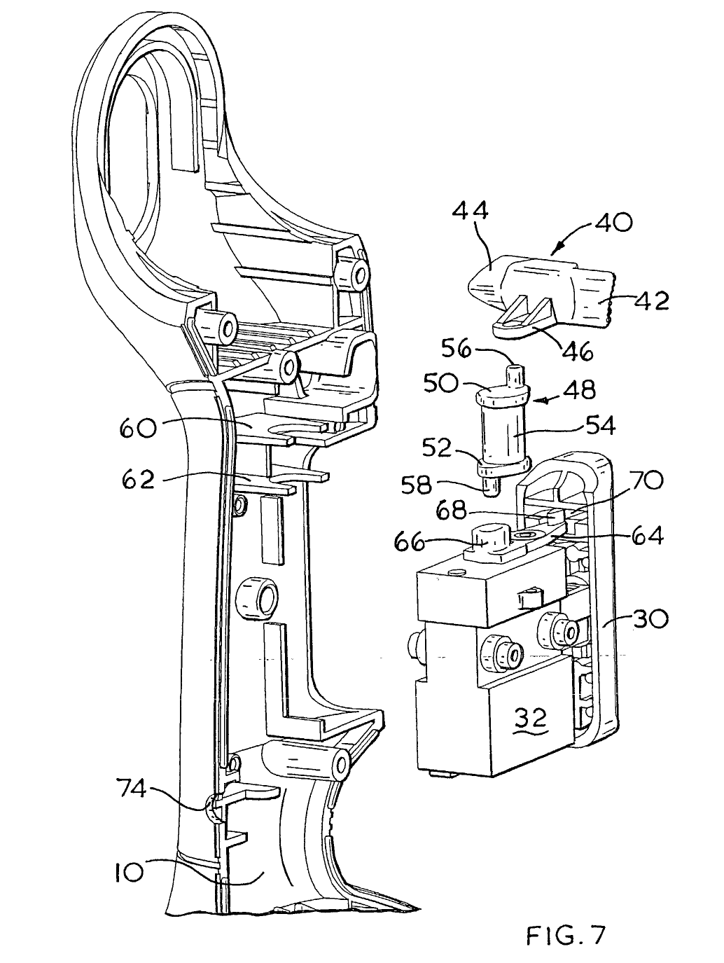

FIG. 7 shows an exploded view of the switch and the direction selector;

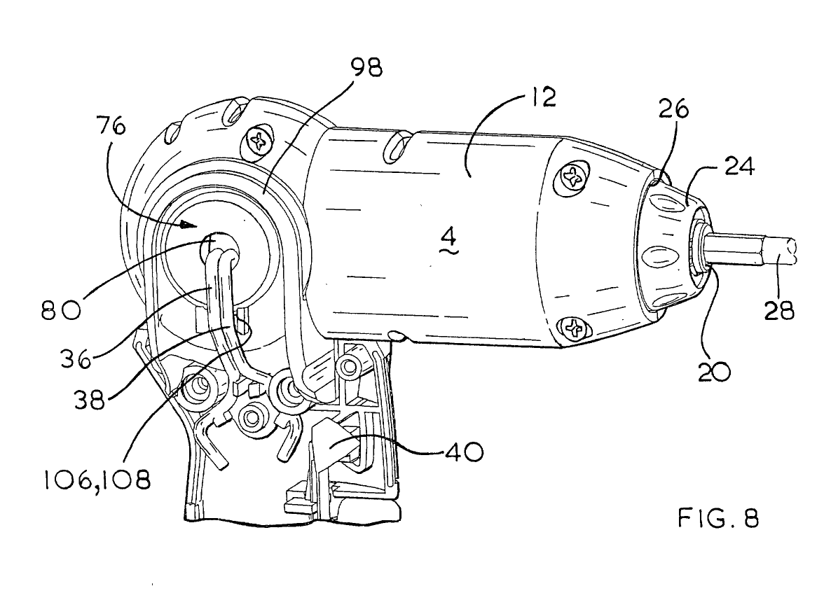

FIG. 8 shows a side cut-away view of the entry point of electrical wires into the drill head;

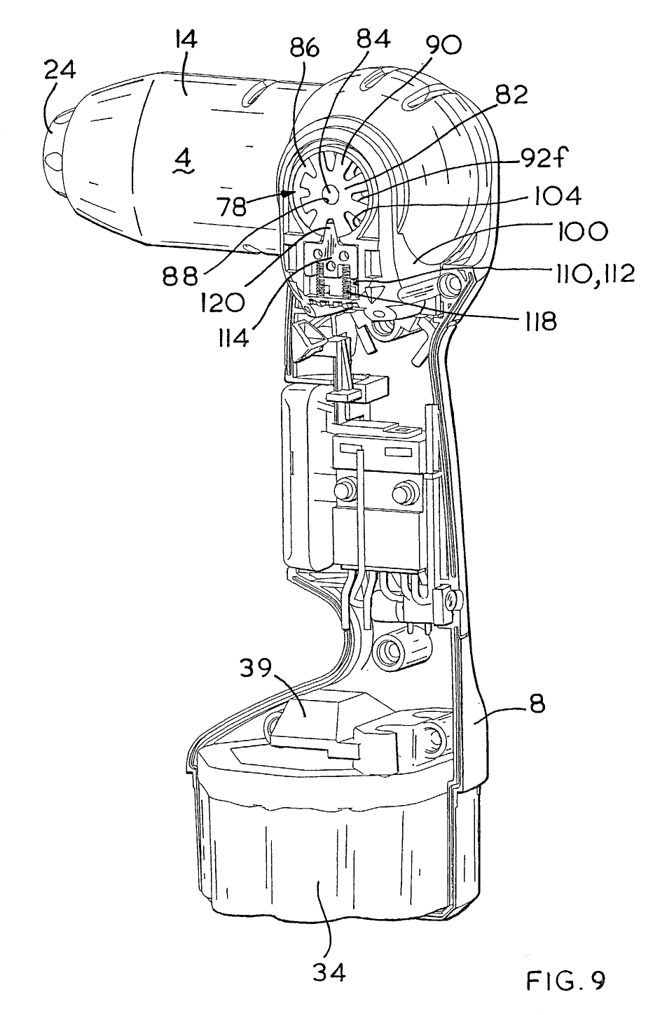

FIG. 9 shows a side cut-away view of the locking mechanism of the power tool;

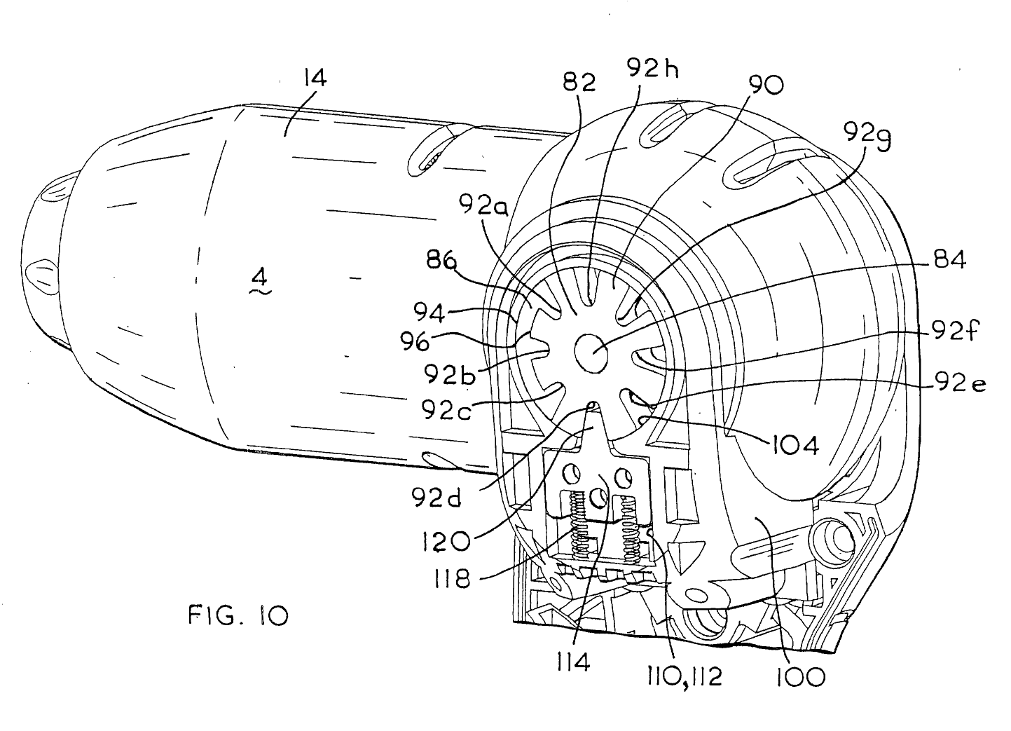

FIG. 10 shows a detailed view of the locking mechanism shown in FIG. 9;

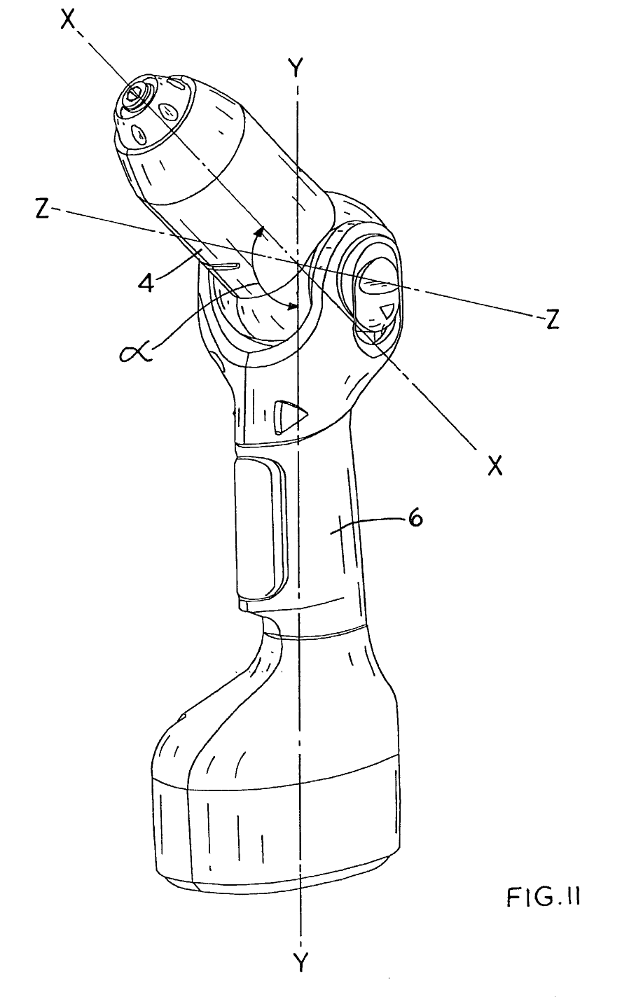

FIG. 11 shows a side perspective view of the power tool with the rotatable drill head inclined at 135° to the handle;

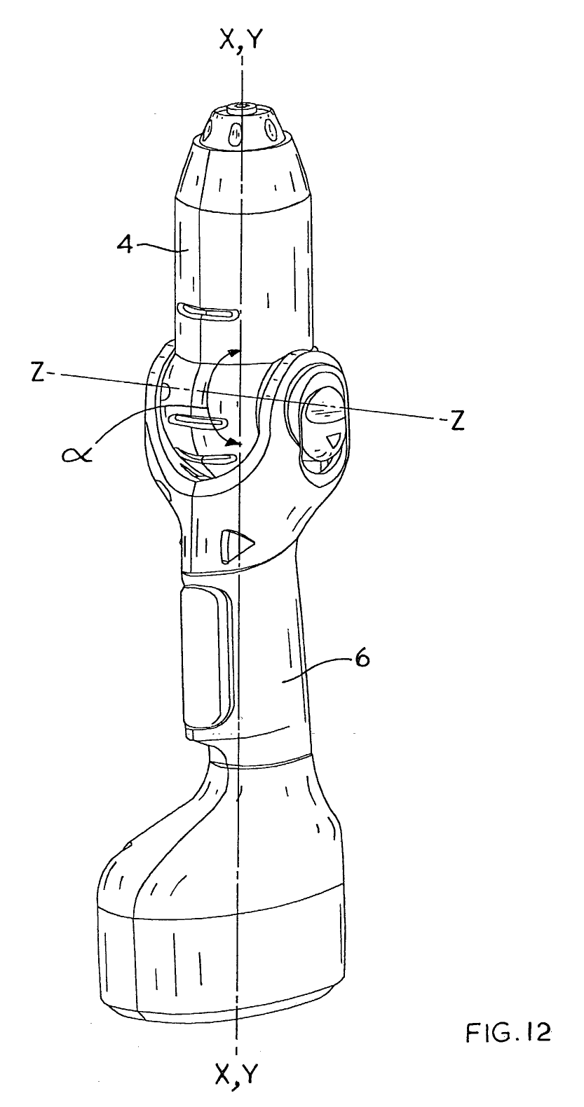

FIG. 12 shows a side perspective view of the power tool with the rotatable drill head in line with the handle; and

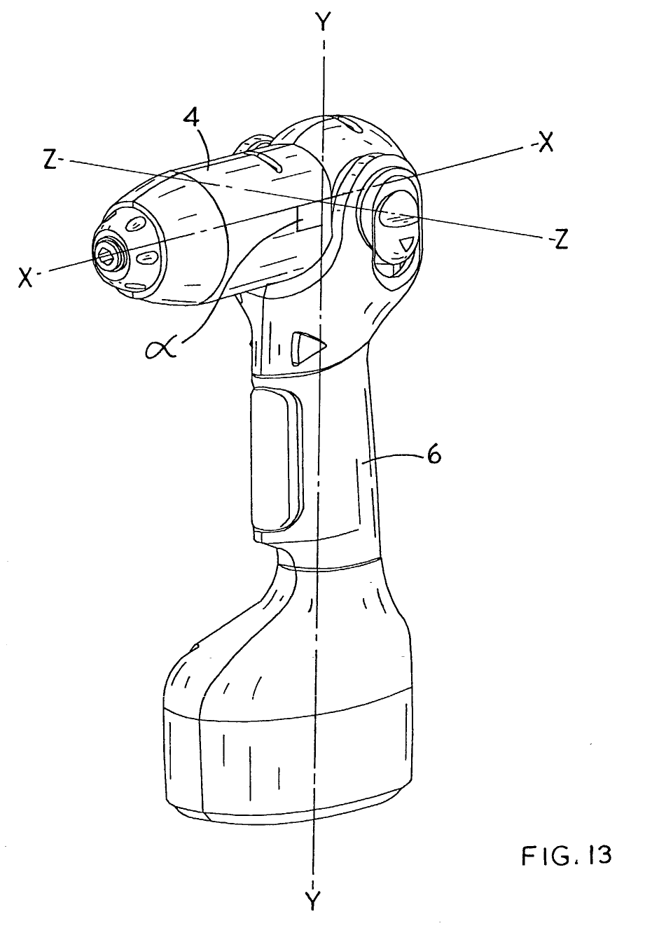

FIG. 13 shows a side perspective view of the power tool with the rotatable drill head perpendicular to the handle.

Referring now to FIGS. 2 and 3, a power tool shown generally as (2) is a drill-driver comprising a substantially cylindrical drill head (4) having a longitudinal axis X and an elongate handle (6) arranged about a longitudinal axis Y. The drill head (4) is pivotally mounted upon the handle (6) and pivots relative to the handle (6) about an axis Z. The handle (6) is formed by a first clamshell (8) and a second clamshell (10) which are joined together by a plurality of screws (not shown). The drill head (4) is formed by a third clamshell (12) and a fourth clamshell (14) which are joined together by a plurality of screws (not shown).

Referring to FIGS. 4 and 5, the drill head (4) comprises an electric motor (16) and a transmission gearbox (not shown) with an output spindle (20). The motor (16) and the gearbox are housed inside the drill head (4). The front end of the drill head (4) comprises a cylindrical gear casing (22) surrounding the gearbox and the output spindle (20). The motor (16) is rotatingly coupled to the gearbox such that rotary motion of the motor (16) is transferred to the output spindle (20) via the gearbox. The end portion of the output spindle (20) has a hex drive coupling (24) attached thereto. The output spindle (20) and the coupling (24) protrude through a hole (26) in the gear casing (22). The output spindle (20) and the coupling (24) rotate about the axis (x). The coupling (24) releasably connects the output spindle (20) to a tool (28) having a conventional hexagonal shank arrangement. Equally, another type of coupling like, for example, a conventional chuck can be attached to the end portion of the output spindle (20) for connection to a tool (28).

The handle (8) comprises a button (30) fixed to a variable speed electrical switch (32). The switch (32) is electrically coupled to a power source (34). The switch (32) is also electrically coupled to the motor (16) by two electrical wires (36,38). The switch (32) is thermally coupled to a heat sink (39) located inside the handle (6). The heat sink (39) is for dissipating excess heat energy created by the internal components of the switch (32). The switch (32) is biased into an OFF position wherein the switch (32) interrupts electrical connection between the power source (38) and the motor (16) such that the motor (16) is denergised and the output spindle (20) does not rotate. Depression of the button (30) moves the switch (32) to an ON position wherein the switch (32) makes electrical connection between the power source (34) and the motor (16). The motor (20) is energised by the electrical current from the power source (34) and the output spindle (20) starts to rotate. Electrical current flowing from the power source (34) to the motor (16) is thus controlled by the switch (32) and is proportional to how far the button (30) is depressed. As depression of the button (30) increases so does flow of electrical current to the motor (16) causing a corresponding increase in the rotational speed of the output spindle (20), and vice versa. When the button (30) is released the switch (32) returns to the OFF position to interrupt the electrical connection between the power source (34) and the motor (16) thus causing denergision of the motor (16).

Referring to FIGS. 6 and 7, the handle (6) comprises a direction selector (40) for selecting the rotational direction of the motor (16) and the output spindle (20). The direction selector (40) is approximately T-shaped and comprises a forward button (42) on one side, a reverse button (44) on the other side, and a flange (46) in the middle. To support the direction selector (40) the forward (42) and reverse (44) buttons partially protrude through an aperture in each of the first (8) and second (10) clamshells respectively. The handle also comprises a barrel (48) with an upper flange (50), a lower flange (52) and a central cylinder (54) located between the upper and lower flanges (52,54). The barrel's flanges (50,52) each have a mainly circular circumference part which is interrupted by a protruding part and are shaped like a tear-drop. The circular part of upper and lower flanges (50,52) has a diameter greater than the central cylinder (54). The protruding part of the upper flange (50) has an upper spigot (56). The protruding part of the lower flange (54) has a lower spigot (58). The upper and lower spigots (56,58) are eccentric with respect the axis of the central cylinder (54) and point axially away from the central cylinder (54). The barrel (48) is supported for pivotal rotation by a pair of brackets (60,62) which are moulded into interior of the handle's clamshells (8,10). The brackets (60,62) surround the central cylinder (54) to support the barrel (48) against lateral movement. The brackets (60,62) abut the inner faces of the upper and lower flanges (50,52) to support the barrel (48) against axial movement. The handle (6) further comprises an arm (64) with a hollow cylindrical hub (66) at one end and a finger (68) at the other end. The arm (64) is pivotally coupled to the internal components of the switch (32) at a point midway between the hub (66) and the finger (68). The arm (64) can pivot between a forward position, a central position and a reverse position. Pivotal movement of the arm (64) from its forward position to its reverse position, and vice versa, causes the switch (32) to change the polarity of the electrical wires (36,38), as explained in more detail below.

The direction selector (40) is mechanically coupled to the switch (32) via the barrel (48) and the arm (64) in the following manner. The barrel's upper spigot (56) engages the direction selector (40) by protruding through a hole in the flange (46). The barrel's lower spigot (58) is seated within the arm's hollow cylindrical hub (66) in the manner of a trunnion arrangement. As such, depression of the forward button (42) slides the direction selector (40) and the upper spigot (56) in one direction thereby rotating the barrel (48) about its axis. Rotation of the barrel (48) moves the lower spigot (58) in the opposite direction thereby pivoting the arm (64) into its forward position. Depression of the reverse button (44) reverses this sequence and causes the arm (64) to pivot from its forward position to its reverse position.

When the arm (64) is in its forward position the polarity of the wires (36,38) causes the motor (16) to turn the output spindle (20) in a clockwise direction when the switch (32) is in the ON position. When the arm (64) in its reverse position the polarity of the wires (36,38) is reversed and the motor (16) to turns the output spindle (20) in an anti-clockwise direction when the switch (32) is in the ON position. When the arm (64) is in its central position the arm's finger (68) is aligned with and abuts a central stop (70) on the interior of the button (30) thereby preventing depression of the button (30) and locking the switch (32) in the OFF position.

The direction selector's buttons (42,44) are arrowhead shaped. The apex of the forward button (42) points forward to give the user a visual and tangible indication that depression of the forward button (42) causes the output spindle (20) to rotate in a clockwise direction (i.e. the rotational direction causing a screw or drill bit to be driven “forward” into a work piece) when the switch (32) is in the ON position. Conversely, the apex of the reverse button (44) points backward to give the user a visual and tangible indication that depression of the reverse button (42) causes the output spindle (20) to rotate in an anti-clockwise direction when the switch (32) is in the ON position.

The power source is a rechargeable battery pack (34) housed inside the bottom of the handle (6). To improve the electrical charge of the battery pack (34), thereby increasing operating life, the battery pack (34) is relatively bulky causing the handle (6) to protrude on the side of the switch button (30). The battery pack (34) is electrically coupled to a battery recharger socket (72) located at the lower end of the handle (6). The battery recharger socket (72) protrudes through a small aperture (74) in the handle (6) to provide an electrical link between the battery pack (34) and an external battery recharging source (not shown). Alternatively, the power source may be a rechargeable battery detachably fixed to the handle (6), or a mains electrical supply.

Returning to FIGS. 4 and 5, the drill head (4) has a first cylindrical hub (76) and a second cylindrical hub (78) both located part way along the length of the drill head (4), remote from the output spindle (20). The first and second hubs (76,78) are located on opposite sides of the drill head (4). The first and second hubs (76, 78) are substantially the same diameter and both arranged about axis Z. The first and second hubs (76, 78) extend from the drill head (4) in diametrically opposed directions along axis Z. Axis Z is perpendicular to axis's X and Y.

Referring to FIG. 8, the first cylindrical hub (76) is moulded into the third clam shell (12) of the drill head (4). The first cylindrical hub (76) comprises a central inner aperture (80) co-axial with axis Z. The inner aperture (80) provides an entry point to the interior of the drill head (4). Referring to FIGS. 9 and 10, the second hub (78) comprises a circular toothed wheel (82), a protrusion (86) and, a cylindrical spigot (84) having axis Z. The protrusion (86) and the spigot (84) are moulded into the fourth clam shell (14) of the drill head (4). The wheel (82) comprises a central aperture (88) and a plurality of teeth (90) arranged equi-angularly around the circumference of the wheel (82). The toothed wheel (82) has eight teeth (90) juxtaposed by eight recesses (92) for engagement with part of a locking plate, which is described in more detail below. The eight teeth (90) are arranged at 45° intervals about the axis Z. The wheel (82) is press fitted upon the fourth clam shell (14). Two of the eight teeth (90) are shorter than the outer diameter of the wheel (82). The protrusion (86) has a curved exterior face (94) and an interior face (96) shaped to surround the two short teeth (90) and engage three recesses (92a, 92b, 92c) adjacent the two short teeth (90) thereby preventing rotation of the wheel (82) relative to the drill head (4). The spigot (84) protrudes through the aperture (88). The outer diameter of the spigot (84) is slightly larger that the diameter of the aperture (88) such that interference fit between the spigot (84) and the circumference of the aperture (88) holds the wheel (82) upon the drill head (4). The curved exterior face (94) of the protrusion (86) and the tips of the teeth (90) collectively describe the outer circumference of the second hub (78). The wheel (82) is made of steel, Alternatively, the wheel (82) may be made of another suitable hard material.

Returning again to FIGS. 4 and 5, located at the top end of the handle (6) (opposite end to the battery pack) is a first supporting bracket (98) and a second supporting bracket (100) each shaped to nest in the interior of the first and the second clamshells (8,10) of the handle (6), respectively. The first bracket (98) has a circular aperture (102) for receiving the first hub (76). The second bracket (100) has a circular aperture (104) for receiving the second hub (76). The first and second hubs (76,78), the first and second bracket apertures (102,104), the first hub aperture (80) and the spigot (84) are co-axial having axis Z. The first and second bracket apertures (102,104) act as a yoke in which the first and second hubs (76,78) are supported for pivotal rotation relative to the handle (6). As such, the first and second bracket apertures (102,104) provide pivotal support to the first and second hubs (76,78), respectively, to allow the drill head (4) to pivot relative the handle (6) about axis Z.

Returning to FIG. 8, the first support bracket (98) has a first walled recess (106) facing the interior of the first clam shell (8) of the handle (6). A cavity (108) bounded by the walled recess (106) and the interior of the first clam shell (8) is formed there between. The cavity (108) provides a connecting passageway from the interior of the handle (6) to first hub (76) for the wires (36,38). Accordingly, the wires (36,38) travel from the switch (32) via the cavity (108) through the first hub's aperture (80) to the motor (20) inside the drill head (4).

Returning to FIGS. 9 and 10, The second support bracket (100) has a second walled recess (110) facing the interior of the first clam shell (10) of the handle (6). A space (112) bounded by the second walled recess (110) and the interior of the second clam shell (10) is formed there between. The space (112) contains a locking plate (114), a lock release button (116) fixed to the locking plate (114), and two helical springs (118). The locking plate (114) has a tongue (120) which is for locking engagement with any one of the five recesses (92d to 92h) of the toothed wheel (82) not occupied by the interior face (96) of the protrusion (86).

The locking plate (114), the lock release button (116), and the two helical springs (118) collectively form a locking mechanism for locking pivotal movement of the head (4) relative to the handle (6) about the axis Z. The tongue (120) of the locking plate (114) is biased into engagement with a recess (92) by the springs (118), thereby locking pivotal movement of the head (4) relative to the handle (6). To allow pivotal movement of the head (4) relative to the handle (6) the user disengages the tongue (120) from a recess (92) by sliding the locking plate (114) and the release button (116) against the bias of the springs (118). Sliding movement of the locking plate (114) is guided by the second walled recess (110). Access to the release button (116) for operation of the locking plate (114) is provided by a hole (122) in the top end of the second clamshell (10) of the handle (6).

Referring now to FIGS. 10 to 13, axis Z is the axis about which the head (4) pivots with respect to the handle (6). Axis Y represents the position of the handle (6) and axis X represents the position of the drill head (4). Both axis X and Y remain perpendicular to axis Z regardless of the orientation of the drill head (4) in relation to the handle (8). The included angle between axis X and Y is referred to as angle α. Only angle α varies when the drill head (4) changes its orientation in relation to the handle (8) by pivoting about the axis Z. Angle α is dictated by which one of the five unoccupied recesses (92d to 92h) engages the tongue (120) of the locking plate (114). Angle α is 90° when recess (92d) engages the tongue (120), as shown in FIG. 13. Recess (92e) is located 45° anti-clockwise from recess (92d), therefore angle α is 135° when recess (92e) engages the tongue (120), as shown in FIG. 11. Angle α is 180°, 225° and 270° when one of the three respective subsequent recesses (92f, 92g, 92h) engage the tongue (120).

In the illustrated embodiment of the present invention, angle α can be set to five positions within a range of 180°, according to which one of the five unoccupied recesses (92d to 92h) engages the locking plate (114). However the range of angle α can be increased from 180° by reducing the number of recesses (92) engaged by the interior face (96) of the protrusion (86) from three recesses (92a, 92b, 92c) to two recesses, or even only one recess. Also, the number of positions within the range of angle α can be varied by changing the number of recesses (92) and teeth (90), or varying the angular spacing between adjacent recesses (92) and teeth (90) around the circumference of the toothed wheel (82).

1. A switch mechanism for assisting accurate control of a power tool, which power tool comprises a variable output controlled by the switch mechanism wherein the shape of at least one part of the switch mechanism which is activated by a user indicates the manner in which the switch mechanism controls the output when that part of the switch mechanism is activated.

2. A switch mechanism as claimed in claim 1, wherein the switch mechanism controls the output by moving between a plurality of switch positions and the output is variable between a plurality of output values, each one of the plurality of switch positions corresponding to a respective output value.

3. A switch mechanism as claimed in claim 2, wherein the at least one part of the switch mechanism comprises a plurality of buttons and the switch mechanism is moved to any one of the plurality of switch positions by activation of a respective button, each one of the plurality of buttons corresponding to a respective output value.

4. A switch mechanism as claimed in claim 3, wherein each one of the plurality of buttons is shaped to indicate a respective corresponding output value.

5. A switch mechanism as claimed in claim 2, wherein the at least one part of the switch mechanism comprises two push buttons and the switch mechanism is moved to a corresponding switch position by depression of one of the two push buttons.

6. A switch mechanism as claimed in claim 5, wherein the plurality of switch positions comprises:
a forward switch position corresponding to a forward output value;
a central switch position corresponding to a zero output value; and
a reverse switch position corresponding to a reverse output value;
and the two push buttons comprise:
a forward button shaped as a forward orientated arrow head; and
a reverse button shaped as a reverse orientated arrowhead;
wherein depression of the forward button moves the switch mechanism to the forward switch position and depression of the reverse button moves the switch mechanism to the reverse switch position.

7. A switch mechanism as claimed in claim 6, wherein the central switch position is located between the forward switch position and the reverse switch position.

8. A switch mechanism as claimed in claim 2, wherein the power tool comprises a second switch for controlling the output, wherein control of the output value by the second switch is interdependent with the switch position of the switch mechanism.

9. A switch mechanism as claimed in claim 8, wherein the switch mechanism is direction selector switch and the second switch is an electrical power switch.
